(19) United States
(12) Patent Application Publication
(10) Pub. No.: US 2021/0051367 A1
(43) Pub. Date: Feb. 18, 2021

(54) SYSTEMS AND METHODS FOR AUDIENCE MEASUREMENT ANALYSIS

(71) Applicant: The Nielsen Company (US), LLC, New York, NY (US)

(72) Inventors: Josephine Holz, New York, NY (US); Kumar Rao, Sunnyvale, CA (US); Brett Morgner Baden, Chicago, IL (US)

(21) Appl. No.: 16/836,627

(22) Filed: Mar. 31, 2020

Related U.S. Application Data
(63) Continuation of application No. 15/206,919, filed on Jul. 11, 2016, now abandoned.
Application No. 15/206,919 is a continuation of application No. 13/925,493, filed on Jun. 24, 2013, now abandoned.
(60) Provisional application No. 61/838,238, filed on Jun. 22, 2013.
(60) Provisional application No. 61/663,274, filed on Jun. 22, 2012.

(51) Int. Cl. H04N 21/442; G06Q 30/02; H04L 29/06; H04N 21/234; H04N 21/2668; H04N 21/475; H04N 21/81; H04N 21/845

(52) U.S. Cl. CPC H04N 21/44222; G06Q 30/0201; G06Q 30/02; H04L 65/60; H04N 21/845; H04N 21/2668; H04N 21/4756; H04N 21/812; H04N 21/23424

(57) ABSTRACT

Methods, apparatus, systems, and computer-readable storage media are disclosed for audience measurement analysis. An example method includes normalizing a data set associated with access to a first episode of first media during a first time period and access to a second episode of the first media during a second time period into a normalized data set, combining the first normalized data set into first and second equity scores for the first media respectively corresponding to the time periods, determining first and second ratings for television broadcast of the first and second episodes of the first media during the time periods, producing an engagement model that defines a relationship between the equity scores and the ratings, and predicting a future rating of a television broadcast of a third episode of the first media for a third time period if advertising associated with the first media is adjusted.

### RELATED APPLICATIONS

This patent arises from a continuation of U.S. patent application Ser. No. 15/206,919, entitled “Systems and Methods for Audience Measurement Analysis,” which was filed on Jul. 11, 2016, which is a continuation of U.S. patent application Ser. No. 13/925,493, entitled “Systems and Methods for Audience Measurement Analysis,” which was filed on Jun. 24, 2013, which claims the benefit of and priority to U.S. Provisional Patent Application Ser. No. 61/838,238, entitled “Systems and Methods for Audience Measurement Analysis,” which was filed on Jun. 22, 2013, and U.S. Provisional Patent Application Ser. No. 61/663,274, entitled “Systems and Methods for Audience Measurement Analysis,” which was filed on Jun. 22, 2012. U.S. patent application Ser. No. 15/206,919, U.S. patent application Ser. No. 13/925,493, U.S. Provisional Patent Application Ser. No. 61/838,238 and U.S. Provisional Patent Application Ser. No. 61/663,274 are hereby incorporated herein by reference in their respective entireties.

### FIELD OF THE DISCLOSURE

The present disclosure relates generally to audience measurement and, more particularly, to systems and methods for audience measurement analysis.

### BACKGROUND

Audience measurement of media, (e.g., content and/or advertisements presented by any type of medium such as television, in theater movies, radio, Internet, etc.), is typically carried out by monitoring media exposure of panelists that are statistically selected to represent particular demographic groups. Using various statistical methods, the captured media exposure data is processed with the collected demographic information to determine the size and demographic composition of the audience(s) for media of interest. The audience size and demographic information is valuable to advertisers, broadcasters and/or other entities. For example, audience size and demographic information is a factor in the placement of advertisements, as well as a factor in valuing commercial time slots during a particular program.

### BRIEF DESCRIPTION OF THE DRAWINGS

FIG. 1 illustrates an example system for audience measurement analysis implemented in accordance with the teachings of this disclosure.

FIG. 2 illustrates an example implementation of the equity analyzer of FIG. 1.

FIG. 3 is a flow diagram representative of example machine readable instructions that may be executed to implement the example equity analyzer of FIG. 2.

FIG. 4 is a flow diagram representative of example machine readable instructions that may be executed to implement the example equity score calculator of FIG. 2.

FIG. 5 is a flow diagram representative of example machine readable instructions that may be executed to implement the example equity modeler of FIG. 2.

FIGS. 6-9 illustrate example reports created by the equity analyzer of FIGS. 1 and/or 2.

FIG. 10 is a block diagram of an example processor platform that may be used to execute the instructions of FIGS. 3, 4 and/or 5 to implement the example equity analyzer of FIGS. 1 and/or 2, the example equity score calculator of FIG. 2, the example equity modeler of FIG. 2, and/or, more generally, the example system of FIG. 1.

### DETAILED DESCRIPTION

Audience measurement companies monitor consumer exposure to media (e.g., television content and/or advertisements, radio content and/or advertisements, Internet content and/or advertisements, streaming content and/or advertisements, signage, outdoor advertising, in theater movies, etc.). In some instances, audience measurement companies survey consumers to obtain and/or determine information regarding exposure to media and/or to collect demographic information of the consumers. Exposure information is used to develop statistics such as, for example, ratings (e.g., a percentage of an audience that is exposed to media), reach (e.g., a percentage of an audience that is exposed to a single occurrence of media), frequency (e.g., an average number of times that audience members are exposed to media), etc. Exposure and/or demographic information may be valuable to companies in, for example, determining a marketing strategy and/or evaluating the effectiveness of a marketing strategy.

Consumer engagement is also of interest to companies such as content providers (e.g., television and/or radio networks) and advertisers. Consumer engagement represents consumers' interest in, interaction with, and/or loyalty to media. For example, an engaged consumer may interact with media or related material and/or information by visiting websites associated with media, purchasing goods associated with media, posting comments on social media websites about media, etc. Such consumer interactions may not be reflected in traditional ratings data. Accordingly, companies may desire a manner to evaluate consumer exposure to media that incorporates the various ways that consumers engage with (e.g., interact with) media and/or related materials and/or related information.

Examples disclosed herein facilitate measuring and/or evaluating consumer interaction with media in a variety of manners. Examples disclosed herein collect and/or determine interaction type data to evaluate consumer interaction with media. As used herein, interaction type data is defined to be data reflecting different types of user contact with media and/or related materials and/or related information. As used herein, interaction type data may include different types of exposure data such as media performance data, live media exposure data, delayed media exposure data, and/or online media exposure data. As used herein, interaction type data may also include engagement data such as social media interaction data, purchase data, and/or media activity data. As used herein, interaction type data may also include media performance data such as reach data, frequency data, and/or media ratings data.

As used herein, live media exposure data is defined to be data reflecting amounts of consumer exposure to live media (e.g., exposure to content and/or ads during a live television broadcast). As used herein, delayed media exposure data is defined to be data reflecting amounts of consumer exposure to media at a time later than the media broadcast (e.g., exposure to recorded content and/or ads). As used herein, online media exposure data is defined to be data reflecting amounts of consumer exposure to online media (e.g., webpages, streaming media, etc.). As used herein, social media interaction data is defined to be data reflecting participation in an online exchange of information that mentions or identifies media of interest, and/or a product, service, and/or actor mentioned or otherwise associated with and/or identified in the media to which the consumer has been exposed. An online exchange may be a posting of, or response to, a message and/or comment on a blog or social network site (e.g., Facebook), an email, a Tweet over a service such as Twitter, etc. As used herein, purchase data is defined as data reflecting purchases made by consumers of a product or service mentioned or otherwise identified in and/or associated with media to which the consumer has been exposed. As used herein, media activity data is defined to be data reflecting different types of activities engaged in by consumers in relation to media. As used herein, media performance data is defined to be data concerning the reach, frequency, ratings, and/or recall of the corresponding media. As used herein, ratings data is defined to be data reflecting a percentage of an audience that is exposed to media. As used herein, recall of media refers to a consumer's memory of media (e.g., how much of an impression the media made on the consumer).

Interaction type data is collected and/or analyzed to provide clients (e.g., television networks, advertisers, etc.) with reports illustrating strength(s) of media in terms of the different types of consumer interaction the media receives. For example, interaction type data may be used to provide advertisers with information about what media (e.g., media programs) may provide an environment in which advertisements would reach engaged and receptive consumers (e.g., what media would present the best advertising opportunity).

Examples disclosed herein collect and/or develop interaction type data such as live media exposure data, delayed media exposure data, online media exposure data, social media exposure data, purchase data, and/or media performance data. Examples disclosed herein determine an equity score for media being analyzed based on the interaction type data. An equity score is a measure of engagement with and/or loyalty to media.

To determine equity scores for the analyzed media, examples disclosed herein combine different types of interaction type data related to the media being analyzed. As explained below, different types of interaction type data may be weighted differently. Different interaction type data (e.g., live media exposure data, delayed media exposure data, online media exposure data, social media interaction data, purchase data, and/or media performance data), may be in different units of measure such as television rating scores, DVD sales, etc. To combine such different types of interaction type data, examples disclosed herein normalize the collected interaction type data to a single and/or same scale. In some examples, the interaction type data is normalized such that, for each type of interaction, a single score is computed that reflects the strength of the corresponding media relative to other media in the same type of interaction (e.g., amounts of online discussions may be compared between two television programs). For example, for each type of interaction for media of interest, the normalized interaction type data reflects how that media compares to an average level of interactions achieved by other media in the past. In some examples, the interaction type data is normalized such that each type of interaction type data is scored with a mean of zero (0) and a standard deviation of one (1). In such examples, the interaction type data is scored with a mean of zero so that positive scores indicate above average consumer interaction, scores of zero indicate average consumer interaction, and negative scores indicate below average consumer interaction. In some examples, because the different interaction type data are all scored on the same unitless scale, two of more different types of interaction type data (e.g., ratings and sales) can be combined into one composite equity score.

In other words, once the interaction type data is normalized, examples disclosed herein combine the normalized interaction type scores for the various types of interaction (e.g., DVD sales and social media discussions) to determine the equity score for the media being analyzed. For example, the normalized interaction type scores are summed to determine the equity score for each media being analyzed. In some examples, different types of interaction type data may be weighted when determining the equity score so that particular types of interaction type data have a greater impact on the equity score than other types of interaction type data. For example, live media exposure data may be weighted more heavily than media purchase data. As noted above, the equity score is a measure of engagement with the media.

Examples disclosed herein also facilitate using consumer interaction with media to predict media performance characteristics such as commercial retention, advertising recall, ratings growth, etc. Examples disclosed herein collect and/or determine media performance data. As used herein, media performance data is defined to be data reflecting historical performance of media such as exposure duration data, media reach data, frequency data, exposure data, and/or ratings data. As used herein, exposure duration data is defined to be a time period of exposure to media. As used herein, media reach data is defined to be percentages of audiences exposed to an occurrence of media.

As used herein, media activity is defined to be data reflecting different types of activities engaged in by consumers in relation to media. As used herein, media activity data includes webpage visitor data, streaming media data, and/or online discussion data. As used herein, webpage visitor data is defined to be data reflecting a number of unique visitors to a webpage associated with media. As used herein, streaming media data is defined to be data reflecting numbers of people accessing a portion of streaming media. As used herein, online discussion data is defined to be data reflecting numbers of mentions of media on webpages, social media sites, sentiment of discussions (e.g., positive, negative, neutral), etc.

Media performance data and/or media activity data is collected and/or analyzed to provide clients (e.g., television networks, advertisers, etc.) with reports including predictions related to media performance characteristics (e.g., ratings growth).

Examples disclosed herein develop models using the equity scores and/or interaction type data such as media performance data and/or media activity data to project and/or predict consumer engagement with media. In some examples, a model is created to predict ratings growth of media based on media performance data (e.g., exposure duration data, media reach data, media exposure data, etc.) and media activity data (e.g., webpage visitor data, media streaming media data, online discussion data, etc.). In some examples, models are created based on a particular demographic group to be analyzed in relation to media. For example, a first model may be created to predict ratings growth in relation to females and another (second) model may be created to predict ratings growth in relation to males. Examples disclosed herein use the results of the modeling to create reports to illustrate and/or predict consumer interaction and/or engagement with the media of interest.

Clients of audience measurement companies may use the equity score(s) and/or engagement reports provided by examples disclosed herein to analyze media and/or consumer engagement therewith. For example, using reports illustrating various types of consumer engagement with media, a client may take action(s) to reduce recording and playback of media by incentivizing live media exposure if the reports indicate higher levels of engagement are achieved for live media exposure. In some examples, clients may increase advertising spending for media with high consumer engagement as consumers of that media may be more receptive to advertising than consumers of other media. In some examples, clients may increase advertising spending for media with lower ratings, but with high consumer engagement if this product will achieve better sales in this manner. In some examples, clients use consumer engagement reports to determine media that may act as positive advertising vehicles.

Example methods, apparatus, systems, and/or computer-readable storage media disclosed herein provide audience measurement analysis. For instance, a disclosed example method includes determining an engagement model defining a relationship between media performance data, media activity data, and a rating score. The media performance data is associated with a first time period and the media activity data associated with a second time period where the second time period is before the first time period. As used herein, the second time period is before the first time period when the end of the second time period is the start of the first time period, when the second time period immediately precedes the first time period, when the start of the second time period is before the first time period and the first and the second time periods overlap, when the second time period precedes the first time period and the first and the second time periods do not overlap, etc. The example method includes applying first media performance data and first media activity data associated with first media to the engagement model to determine coefficients for parameters of the engagement model. The parameters of the engagement model are associated with the media performance data and the media activity data. The example method includes applying second media performance data and second media activity data associated with second media to the engagement model using the coefficients to determine a rating score for the second media.

A disclosed example system includes an equity modeler to determine an engagement model defining a relationship between media performance data, media activity data, and a rating score. In some examples, the media performance data is associated with a first time period and the media activity data is associated with a second time period where the second time period is before the first time period. The example equity modeler is to apply first media performance data and first media activity data associated with first media to the engagement model to determine coefficients for parameters of the engagement model. The parameters of the engagement model are associated with the media performance data and the media activity data. The example equity modeler is to apply second media performance data and second media activity data associated with second media to the engagement model using the coefficients to determine a rating score for the second media.

A disclosed example computer-readable storage medium comprises instructions that, when executed, cause a computing device to at least determine an engagement model defining a relationship between media performance data, media activity data, and a rating score. In some examples, the media performance data is associated with a first time period and the media activity data is associated with a second time period where the second time period is before the first time period. The example instructions cause the computing device to apply first media performance data and first media activity data associated with first media to the engagement model to determine coefficients for parameters of the engagement model. The parameters of the engagement model are associated with the media performance data and the media activity data. The example instructions cause the computing device to apply second media performance data and second media activity data associated with second media to the engagement model using the coefficients to determine a rating score for the second media.

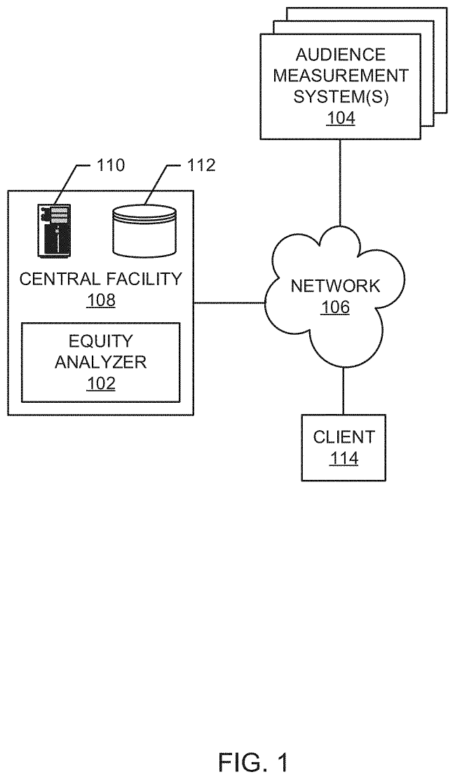

FIG. 1 illustrates an example equity analyzer 102 constructed in accordance with the teachings of this disclosure to analyze interaction type data such as media performance data and/or media activity data to measure the consumer engagement achieved by the media. The interaction type data reflects different types of user contact and/or interaction with media and/or related material and/or information. The media performance data reflects performance of media in terms of media exposure. The media activity data reflects activities of consumers in connection with media and/or related material and/or information. The equity analyzer 102 of the illustrated example uses the interaction type data (e.g., media performance data and/or media activity data) to measure media performance in terms of engagement and/or to predict various media performance characteristics such as commercial retention, advertising recall, ratings growth, etc. associated with media. The equity analyzer 102 of the illustrated example analyzes the interaction type data to provide clients (e.g., media providers such as broadcasters, content creators, manufacturers, advertisers, etc.) with reports illustrating strength(es) and/or weakness(es) of the media and/or predicting media performance (e.g., ratings growth).

The example of FIG. 1 includes audience measurement system(s) 104 to collect interaction type data (e.g., media performance data and/or media activity data). The example audience measurement system(s) 104 of FIG. 1 may be implemented by, for example, an audience measurement company such as The Nielsen Company. In some examples, the audience measurement system(s) 104 collect exposure data such as live media exposure data, delayed media exposure data, online media exposure data, and/or media activity data such as social media interaction data, and/or purchase data. In some examples, the exposure data collected by the audience measurement system(s) 104 is analyzed into media performance data such as exposure duration data, media reach data, frequency data, and/or ratings data. In some examples, the audience measurement system(s) 104 collect additional media activity data such as webpage visitor data, streaming media data, and/or online discussion data. In some examples, the interaction type data collected by the audience measurement system(s) 104 is associated with demographic information (e.g., demographics of consumers exposed to media). For example, the example audience measurement system(s) 104 of FIG. 1 record gender and/or age of participating panelists.

The audience measurement system(s) 104 of the illustrated example send the collected interaction type data and/or demographic information to the example equity analyzer 102 via a network 106. The network 106 of the illustrated example may be implemented using any wired and/or wireless communication system including, for example, one or more of the Internet, telephone lines, a cable system, a satellite system, a cellular communication system, AC power lines, etc.

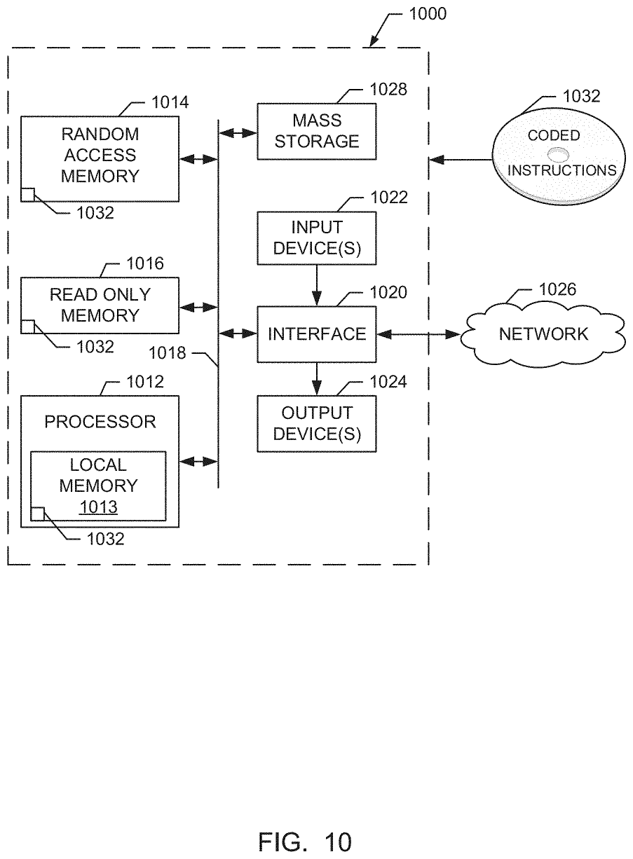

The equity analyzer 102 of the illustrated example is located in a central facility 108 associated with, for example, an audience measurement entity conducting a study. The central facility 108 of the illustrated example collects and/or stores interaction type data such as media performance data, and/or media activity data. The central facility 108 may be, for example, a facility associated with The Nielsen Company (US), LLC or an affiliate of The Nielsen Company (US), LLC. The central facility 108 of the illustrated example includes a server 110 and a database 112 that may be implemented using any number and/or type(s) of suitable processor(s), memor(ies), and/or data storage apparatus such as that shown in FIG. 10.

To analyze the various ways in which consumers interact with media and/or material and/or information related to med, the example equity analyzer 102 uses the interaction type data (e.g., media performance data such as live media exposure data, delayed media exposure data, and/or online media exposure data, media activity data such as social media interaction data and/or purchase data) to determine an equity score for the media being analyzed. For example, for given media being analyzed, interaction type data related to the media is collected by the audience measurement system(s) 104 and analyzed by the example equity analyzer 102. Each media under analysis is given an equity score by the example equity analyzer 102. Equity scores are a measure of engagement with media as they reflect consumer interaction with, pursuit of, and/or loyalty to the media and/or material and/or information related to the media.

In some examples, the example equity analyzer 102 weights the interaction type data (e.g., one or more of live media exposure data, delayed media exposure data, online media exposure data, media activity data, purchase data, and/or ratings data). Additionally and/or alternatively, different data within the same type may be weighted differently. Thus, for example, live exposure data may be weighted more heavily than delayed exposure data, and/or for delayed media exposure data, the example equity analyzer 102 may more heavily weight data reflecting that media was played back more closely to its broadcast or recording time (e.g., two hours after the broadcast time) than data reflecting that media was played back a later time after its broadcast or recording time (e.g., two days after the broadcast time). Weighting interaction type data allows some consumer interactions with media to have an increased positive and/or negative impact on the equity analysis performed by the example equity analyzer 102.

To determine equity scores for media (e.g., content and/or advertisements) being analyzed, the example equity analyzer 102 of FIG. 1 combines the different interaction type data collected and/or developed for the corresponding media. To combine the interaction type data representative of different forms of consumer interaction (e.g., which may be in different units of measure such as television ratings, DVD sales, etc.), the example equity analyzer 102 normalizes each type of the interaction type data. Normalizing each type of interaction type data refers to adjusting values on different scales to a common or standard scale. The interaction type data is normalized to enable comparing the different types of interaction type data and to enable combining the different types of interaction type data into a single score. In some examples, the equity analyzer 102 normalizes the interaction type data such that, for each type of the interaction type data, a single score is computed that reflects the strength of the corresponding media compared to other media with respect to the same type of interaction. For example, for each type of interaction type data, the normalized interaction type data reflects how the corresponding media compares to prior (e.g., historical) media. In some examples, the example equity analyzer 102 normalizes the interaction type data such that each type of interaction type data is scored with a mean of zero (0) and a standard deviation of one (1). In such examples, the example equity analyzer 102 scores the interaction type data with a mean of zero so that positive scores indicate above average consumer interaction, scores of zero indicate average consumer interaction, and negative scores indicate below average consumer interaction. The scores for each particular type of interaction type data may be referred to as “contributing equity scores.” The contributing equity scores are combined to determine an equity score (e.g., an overall equity score) for the media being analyzed.

In some examples, the example equity analyzer 102 determines an equity score for the media being analyzed by summing the normalized interaction type data scores for the media. In some examples, when combining the normalized interaction type data for the media being analyzed, the example equity analyzer 102 weights each type of interaction type data. For example, the example equity analyzer 102 may weight live media exposure data more heavily than purchase data. In some examples, the example equity analyzer 102 weights each type of interaction type data equally. Weighting the normalized interaction type data differently allows particular type(s) of consumer interactions with media to have an increased positive and/or negative impact on the equity analysis performed by the example equity analyzer 102 relative to other type(s) of interactions.

The equity analyzer 102 of the illustrated example also develops models using the interaction type data to project consumer engagement with the media. For instance, models developed by the example equity analyzer 102 define relationships between the media performance data and/or media activity data which may be used to predict a consumer engagement measure (e.g., ratings growth, advertisement recall, etc.). The example equity analyzer 102 uses historical media performance data and/or media activity data to create the model. The example equity analyzer 102 then applies media being analyzed (e.g., for a report) to the model to determine a predicted consumer engagement measure for the media in question.

The example equity analyzer 102 uses the results of the equity modeling and/or the equity scores for the media to create reports to illustrate and/or predict engagement with the media. The equity analyzer 102 of the illustrated example provides the reports to a client 114 to allow the client 114 to analyze and/or act upon the information (e.g., to adjust marketing techniques and/or improve the effectiveness of a marketing campaign associated with the media). For example, the example equity analyzer 102 may predict that media with positive online media exposure data related to streaming media (e.g., media that is streamed online a large amount) will have decreased television ratings indicating that consumer who stream media are not exposed to live media broadcast. In such an example, reports created by the example equity analyzer 102 and provided to the client 114 will illustrate the importance of monetizing media to be made available for streaming to make up for revenue associated with television ratings that may be lost.

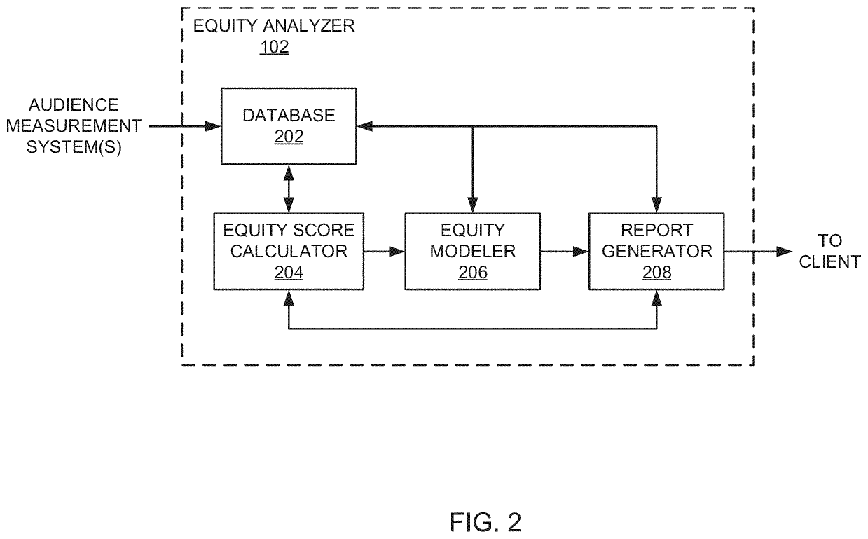

FIG. 2 is a block diagram of an example implementation of the equity analyzer 102 of FIG. 1. Audience measurement systems (e.g., the audience measurement system(s) 104 of FIG. 1) collect interaction type data representative of consumer exposure to and/or interaction with media. The interaction type data is aggregated in, for example, a central facility, such as the central facility 108 of FIG. 1. The equity analyzer 102 of the illustrated example accesses the interaction type data aggregated at the central facility 108 and creates one or more reports to be distributed to one or more clients, such as the client 114 of FIG. 1. The equity analyzer 102 of the illustrated example includes an example database 202, an example equity score calculator 204, an example equity modeler 206, and an example report generator 208.

In the illustrated example, the database 202 receives interaction type data (such as media performance data and/or media activity data) from the audience measurement system(s) 104 and stores the interaction type data. For example, the database 202 receives interaction type data such as live media exposure data, delayed media exposure data, online media exposure data, media activity data, social media interaction data, purchase data, and/or media performance data. In some examples, the interaction type data is based on the measured population as a whole (e.g., all consumers). In some examples, the interaction type data is based on a subset of the measured population (e.g., a group of consumers that may be categorized based on demographic information, such as, for example, age, gender, geographic location, etc.).

The equity score calculator 204 of the illustrated example accesses the interaction type data from the database 202. In the illustrated example, for different types of interaction type data (e.g., delayed media exposure data), the example equity score calculator 204 weights the interaction type data differently. For example, for delayed media exposure data, the example equity score calculator 204 weights data showing that media was played back more closely to its broadcast or recording time (e.g., two days after the broadcast time) more heavily than data showing that media was played back a later time after its broadcast time (e.g., seven days after the broadcast time). Additionally or alternatively, the equity score calculator 204 may weight media exposure data more heavily than delayed exposure data.

The equity score calculator 204 of the illustrated example calculates equity scores for media (e.g., content and/or advertisements) being analyzed. To determine equity scores for media being analyzed, the example equity score calculator 204 combines the interaction type data (e.g., weighted and/or unweighted interaction type data) collected for the corresponding media. To combine the interaction type data representative of different forms of consumer interaction (e.g., which may be in different units of measure such as television ratings, DVD sales, etc.), the example equity score calculator 204 normalizes each type of the interaction type data to a single and/or same scale. The example equity score calculator 204 normalizes the interaction type data to equate the various measurements into a common scale for comparison and/or combination into a single score. In some examples, the example equity score calculator 204 normalizes the interaction type data such that, for each type of the interaction type data, a single score is computed that reflects the strength of that media compared to other media with respect to the same type of interaction.

In some examples, the equity score calculator 204 determines an equity score for the media being analyzed by summing the normalized interaction type data scores for the media. In some examples, when combining the normalized interaction type data for the media being analyzed, the example equity score calculator 204 weights each type of interaction type data. For example, the example equity score calculator 204 may weight live media exposure data more heavily than purchase data. In some examples, the example equity score calculator 204 weights each type of interaction type data equally. The equity score calculator 204 of the illustrated example may weight the normalized interaction type data differently to allow particular type(s) of consumer interactions with media to have an increased positive and/or negative impact on the equity analysis performed by the example equity analyzer 102 relative to other type(s) of interactions. An example equation used by the example equity score calculator 204 to calculate an equity score is illustrated below.

Equity Score=W₁(X₁)+W₂(X₂)+W₃(X₃)+ . . . Wₙ(Xₙ)
where W₁-Wₙ are weights and X₁-Xₙ are interaction type data normalized to unitless values on the same scale (e.g., between −8 and +8)

The equity scores determined by the example equity score calculator 204 are stored at the example database 202 and used by the example report generator 208 to create reports.

The equity modeler 206 of the illustrated example develops models using the media performance data and/or media activity data stored at the example database 202 to project consumer engagement with media. Models developed by the example equity modeler 206 define relationships between the media performance data and/or media activity data and the type of consumer engagement measure to be predicted (e.g., ratings growth). The equity modeler 206 uses collected media performance data and/or media activity data (e.g., historical media performance data and/or media activity data) to determine the relationship between (1) the media performance data and/or media activity data and (2) the predicted consumer engagement measure to create a model. The equity modeler 206 applies data associated with media being analyzed (e.g., for a report) to the model to determine a predicted consumer engagement measure for the media.

In some examples, the equity modeler 206 creates a model to predict ratings growth (or decline) of media based on parameters representative of the media performance data and/or the media activity data. In some examples, to predict ratings growth, the model created by the example equity modeler 206 combines current media performance data (e.g., exposure duration data, media reach data, media exposure data, etc.) and past media activity data (e.g., webpage visitor data, media streaming media data, online discussion data, etc.). Specifically, in some such examples, the model relates a change in ratings over a time period (e.g., from February to March) to a change in media performance data over the same time period (e.g., from February to March) combined with a change in media activity data over a past time period (e.g., from January to February). For example, the engagement model may define a relationship between media performance data and/or media activity data and a rating score (a score reflecting a percentage of an audience that is exposed to media), wherein the media performance data is associated with a first time period and media activity data is associated with a second time period that is before the first time period. An example equation representative of the example model is illustrated below.

ΔY=Y₍ₜ₎−Y₍ₜ₋₁₎=a+f{X₍ₜ₎−X₍ₜ₋₁₎}+g{Z₍ₜ₋₁₎−Z₍ₜ₋₂₎}
where ΔY is the change in ratings, X is the media per f ormance data, Z is the media activity data, and a, f, and g are coefficients
   The example equity modeler 206 analyzes known data (e.g., data from previous/historical time periods) to determine (e.g., using regression or other statistical analysis) the coefficients defining the relationship between the media performance data and/or media activity data and the ratings growth.

The example equity modeler 206 of FIG. 2 applies collected media performance data and/or media activity data (e.g., for a plurality of media programs over historical time periods) to the above equation and solves for the coefficients a, f, and g using, for example, a linear regression analysis or a spline analysis. An example model is illustrated in Table 1 below.

TABLE 1
Linear regression
Number of obs = 283
F (6, 276) = 166.27
Prob > F = 0.0000
R-squared = 0.8443
Root MSE = .72491

| | | Robust | | | | |
|---|---|---|---|---|---|---|
| actlive7mc~a | Coef. | Std. Err. | t | P > \|t\| | [95% Conf. Interval] | |
| totdur | −.0027103 | .0001467 | −18.48 | 0.000 | −.0029991 | −.0024215 |
| avgreach | .2565328 | .0148022 | 17.33 | 0.000 | .2273932 | .2856723 |
| vpvhlive7m~a | .0007384 | .0003861 | 1.91 | 0.057 | −.0000218 | .0014985 |
| netuniquev~i | .0015575 | .0005044 | 3.09 | 0.002 | .0005644 | .0025505 |
| vctotstreams | 6.09e−06 | 4.05e−06 | 1.50 | 0.134 | −1.89e−06 | .0000141 |
| nummen | 3.77e−06 | 8.21e−06 | 0.46 | 0.646 | −.0000124 | .0000199 |
| _cons | .1166403 | .1800198 | 0.65 | 0.518 | −.237746 | .4710265 |

The model of Table 1 is created by the example equity modeler 206 to predict ratings growth (“actlive7mc˜a”) based on changes in: duration of exposure (“totdur”), average reach of media (“avgreach”), amount of exposure to media (“vpvhlive7m˜a”), unique visitors to a webpage associated with media (“netuniquev˜I”), total streams of media (“vctotstreams”), and number of mentions of media (“nummen”). The model of Table 1 includes a constant value (“_cons”) to create an equation representative of the relationships defined in the model. “Coef.” of the model of Table 1 represents the coefficients used to define the relationship between the media performance data (“totdur,” “avgreach,” and “vpvhlive7ma”) and media activity data (“netuniquev˜i,” “vctostreams,” and “nummen”) and the ratings growth (“actlive7mc˜a”). The “Number of obs” of Table 1 represents the number of observations (e.g., the number of media) used in the model analysis. The parameters “Robust Std. Err.,” “t,” “P>|t|,” “[95% Conf. Interval],” “F(6, 276),” “Prob>F,” “R-squared,” and “Root MSE” parameters are standard components of a regression analysis.

An example equation representative of the model of Table 1 is illustrated below.

$$\begin{matrix}Actlive 7 mc \sim a = 0.1166403 - 0.0027103 * totdur + 0.2565328 * avgreach \\ + 0.0007384 * vpvhlive 7 m \sim a + 0.0015575 * netuniquev \sim i \\ + 0.00000609000 * vctotstreams + 0.000003770 * nummen\end{matrix}$$

Once the coefficients have been determined (e.g., via linear regression), the example equity modeler 206 applies the media being analyzed to the model. To apply the media being analyzed to the model, the example equity modeler 206 collects the media performance data and/or media activity data for the media being analyzed from the example database 202. The example equity modeler 206 calculates the predicted ratings growth for the media being analyzed using the equation above with the determined coefficients and the media performance data and/or media activity data. In some examples, the predicted ratings growth can be utilized to predict a change in ratings for a time period for which audience measurement data is not available (e.g., a future time period). The predicted ratings growth calculated by the example equity modeler 206 is sent to the example report generator 208 to be included in a report.

In some examples, the media performance data may be time invariant (e.g., there may be no change in the media performance data) and/or may be considered time invariant. In such an example, the model defining ratings growth based on changes in media performance data and media activity data may consider only media activity data. In other words, where the media performance data is time invariant, the model may define ratings growth based on changes in media activity data alone. A model based on only media activity data may be valuable when, for example, some media performance data is not easily ascertained.

In some examples, a model developed by the example equity modeler 206 may define and/or reflect that media with positive media activity data related to the Internet (e.g., number of visitors of a website, number of visits to a website per visitor, duration of website visits, etc.) will experience a growth in television ratings, and media with positive media activity data related to media streaming (e.g., number of online or on-demand streams, time spent streaming, etc) will experience a decline in television ratings. In other words, a model developed by the example equity modeler 206 may predict that media with many consumers visiting websites associated with the media for longer periods of time will experience increased ratings, but media with many consumers streaming the media will experience decreased ratings.

In some examples, a model developed by the example equity modeler 206 may define that media with positive media performance data related to media playback within a particular amount of time from its broadcast or recording (e.g., within three days of recording) will experience a growth in television ratings and media with positive media performance data related to media playback within a longer amount of time from its broadcast or recording (e.g., within four to seven days of recording) will experience a decline in television ratings. In other words, a model developed by the example equity modeler 206 may predict that media with many consumer exposures four to seven days after the media aired will experience decreased television ratings. In some examples, a model developed by the example equity modeler 206 may define that media with positive media activity data related to social media (e.g., numbers of Twitter posts, etc.) will experience a growth in television ratings.

In some examples, the equity modeler 206 creates models for demographic groups (e.g., based on gender, age, occupation, income, etc.). For example, the equity modeler 206 may create a model to predict ratings growth based on media performance data and/or media activity data associated with women and may create another model to predict ratings growth based on media performance data and/or media activity data associated with men. The example equity modeler 206 may create a model for females and a model for males to distinguish how gender may affect consumer engagement. In such an example, the model associated with females may indicate/report that online consumer interaction and/or online media streaming increases media ratings for females, but the model associated with males may indicate/report that online consumer interaction and/or online media streaming decreases media ratings for males.

Any number and/or type of media performance data and/or media activity data may be used by the example equity modeler 206 to create models. For example, more or fewer categories of media performance data and/or media activity data may be used by the example equity modeler 206.

The report generator 208 of the illustrated example uses the results of the modeling performed at the example equity modeler 206 (e.g., predicted ratings growth scores) and/or the equity scores calculated at the example equity score calculator 204 to create reports to illustrate and/or predict consumer interaction, and/or engagement with the media. The example report generator 208 provides the reports to clients (e.g., the client 114) for analyzing and/or acting upon the information (e.g., adjusting marketing techniques and/or improving the effectiveness of a marketing campaign associated with the media). For example, if the example equity modeler 206 predicts that media with positive online media exposure data related to media streaming will experience decreased television ratings, the example report generator 208 creates reports to illustrate the importance of monetizing media to be made available for streaming to make up for revenue associated with television ratings that may be lost.

In some examples, the example report generator 208 creates a report ranking a plurality of media based on overall equity scores. In such an example, the report generator 208 provides a visual display of how media compares to other media in terms of overall equity scores reflecting consumer engagement. In some examples, the example report generator 208 creates a report showing overall equity scores and contributing equity scores for a plurality of media. In such an example, the report generator 208 provides a visual display of the types of interaction type data positively affecting an overall equity score (e.g., live media exposure data) and the types of interaction type data negatively affecting the overall equity score (e.g., online media exposure data). In some examples, the report generator 208 creates a report comparing equity scores of media based on ratings scores. In such an example, the report generator 208 provides a visual display comparing equity scores to ratings to illustrate that high ratings do not necessarily correspond to high equity scores and vice versa. For example, media with high ratings may have low equity scores, indicating that the consumers of the media are less engaged than consumers of other media.

In some examples, the report generator 208 creates a report showing the results of modeling performed by the example equity modeler 206. Specifically, the example report generator 208 creates a report detailing the predicted ratings growth for the media being analyzed. In some examples, the report generator 208 creates a report indicating the media performance data and/or media activity data having a positive impact on ratings growth (e.g., types of media performance data and/or media activity data causing an increase in ratings growth) and indicating the media performance data and/or media activity data having a negative impact on ratings growth (e.g., types of media performance data and/or media activity data causing a decrease in ratings growth). In some examples, the report generator 208 determines a proportionate ratings growth to facilitate a comparison between media with higher ratings and media with lower ratings. Determining the proportionate ratings growth helps to illustrate the impact of the changes of the media activity data.

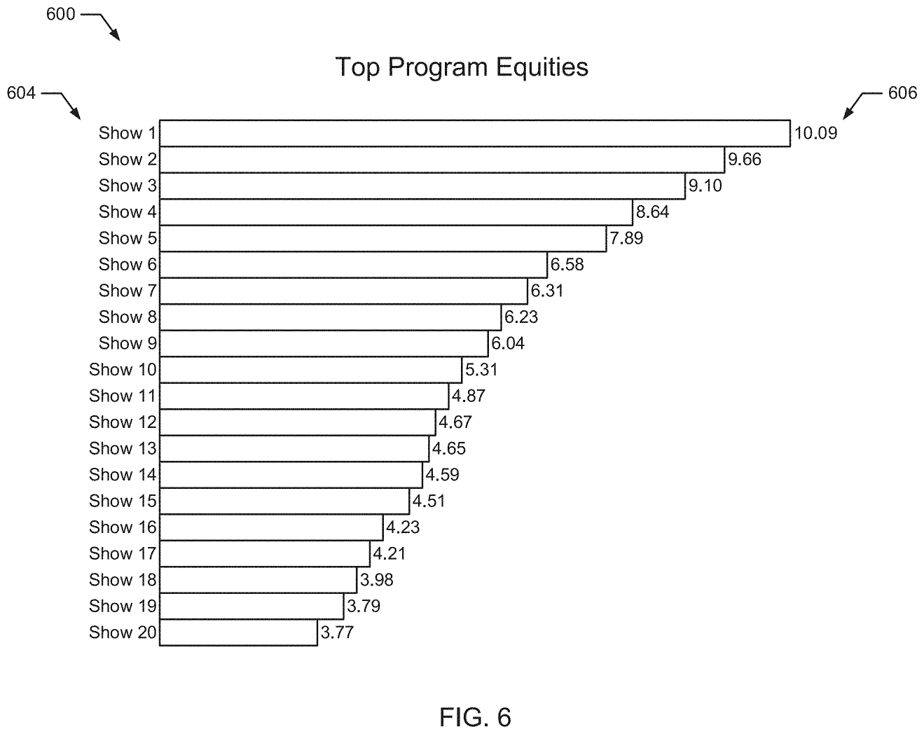

In some examples, the report generator 208 provides a visual display comparing predicted ratings growth to actual ratings growth to illustrate the effectiveness of the modeling performed by the example equity modeler 206. Example reports created by the example report generator 208 and/or, more generally, the example equity analyzer 102, are illustrated in FIGS. 6-9.

While an example manner of implementing the equity analyzer 102 of FIG. 1 is illustrated in FIG. 2, one or more of the elements, processes and/or devices illustrated in FIG. 2 may be combined, divided, re-arranged, omitted, eliminated and/or implemented in any other way. Further, the example database 202, the example equity score calculator 204, the example equity modeler 206, the example report generator 208, and/or, more generally, the example equity analyzer 102 of FIG. 2 may be implemented by hardware, software, firmware and/or any combination of hardware, software and/or firmware. Thus, for example, any of the example database 202, the example equity score calculator 204, the example equity modeler 206, the example report generator 208, and/or, more generally, the example equity analyzer 102 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example database 202, the example equity score calculator 204, the example equity modeler 206, the example report generator 208, and/or, more generally, the example equity analyzer 102 is/are hereby expressly defined to include a tangible computer readable storage device or storage disk such as a memory, a digital versatile disk (DVD), a compact disk (CD), a Blu-ray disk, etc. storing the software and/or firmware. Further still, the example equity analyzer 102 of FIG. 2 may include one or more elements, processes and/or devices in addition to, or instead of, those illustrated in FIG. 2, and/or may include more than one of any or all of the illustrated elements, processes and devices.

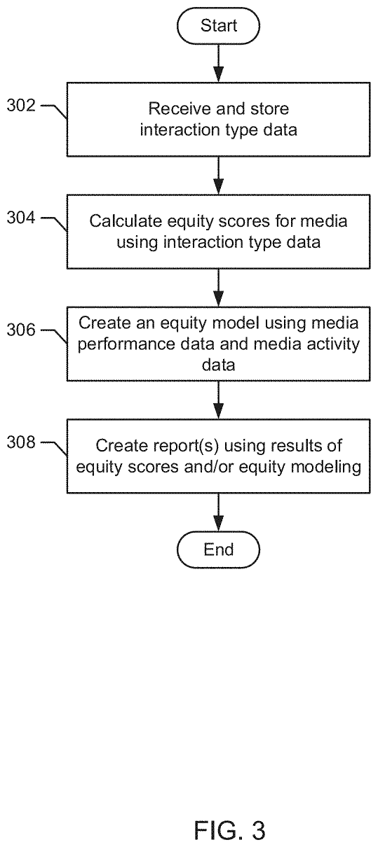

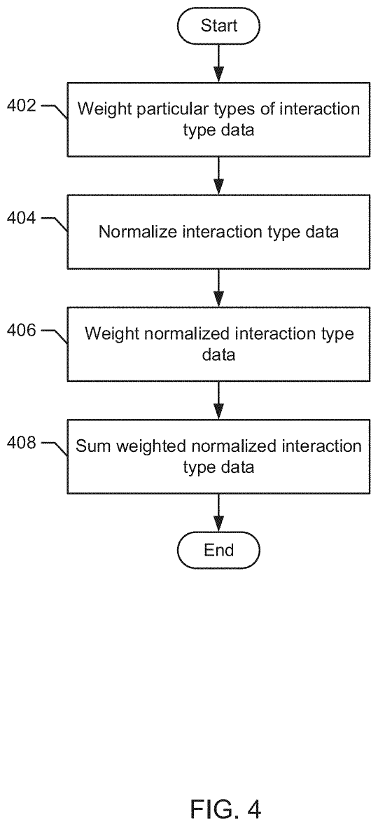

Flowcharts representative of example machine readable instructions for implementing the example equity analyzer 102 of FIGS. 1 and/or 2, the example equity score calculator 204 of FIG. 2, and/or the example equity modeler 206 of FIG. 2 are shown in FIGS. 3, 4, and/or 5. In these examples, the machine readable instructions comprise programs for execution by a processor such as the processor 1012 shown in the example processor platform 1000 discussed below in connection with FIG. 10. The programs may be embodied in software stored on a tangible computer readable storage medium such as a CD-ROM, a floppy disk, a hard drive, a digital versatile disk (DVD), a Blu-ray disk, or a memory associated with the processor 1012, but the entire programs and/or parts thereof could alternatively be executed by a device other than the processor 1012 and/or embodied in firmware or dedicated hardware. Further, although the example programs are described with reference to the flowcharts illustrated in FIGS. 3, 4, and/or 5, many other methods of implementing the example equity analyzer 102, the example equity score calculator 204, and/or the example equity modeler 206 may alternatively be used. For example, the order of execution of the blocks may be changed, and/or some of the blocks described may be changed, eliminated, or combined.

As mentioned above, the example processes of FIGS. 3, 4, and/or 5 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals. As used herein, “tangible computer readable storage medium” and “tangible machine readable storage medium” are used interchangeably. Additionally or alternatively, the example processes of FIGS. 3, 4, and/or 5 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable device or disk and to exclude propagating signals. As used herein, when the phrase “at least” is used as the transition term in a preamble of a claim, it is open-ended in the same manner as the term “comprising” is open ended.

FIG. 3 is a flow diagram representative of example machine readable instructions that may be executed to implement the example equity analyzer 102 of FIGS. 1 and/or 2 to analyze consumer interaction with media. Interaction type data reflecting consumer interaction with media in a variety of manners is collected and the example equity analyzer 102 of the illustrated example uses the interaction type data to predict various media performance characteristics such as commercial retention, advertising recall, ratings growth, etc. associated with the media. The equity analyzer 102 of the illustrated example analyzes the interaction type data such as media performance data and/or media activity data to provide clients (e.g., television networks, advertisers, etc.) with reports illustrating strength of the media performance and/or predictions related to media performance characteristics (e.g., ratings growth).

Initially, the example database 202 receives and stores interaction type data (block 302). Audience measurement systems (e.g., the audience measurement system(s) 104 of FIG. 1) collect interaction type data such as media performance data and/or media activity data representative of consumer interaction with media and the interaction type data is sent to the example database 202. In some examples, the interaction type data is based on the measured population as a whole (e.g., all consumers). In other examples, interaction type data is based on a subset of the measured population (e.g., a group of consumers such as a panel that may be categorized based on demographic information, such as, for example, age, gender, geographic location, etc.) that may be statistically extrapolated to represent the whole population.

The example equity score calculator 204 accesses the interaction type data at the example database 202 and calculates equity scores for the media using the interaction type data (block 304). Equity scores are a measure of engagement related to the media as they reflect consumer interaction with and/or loyalty to the media. An example method to calculate equity scores is described below in connection with FIG. 4.

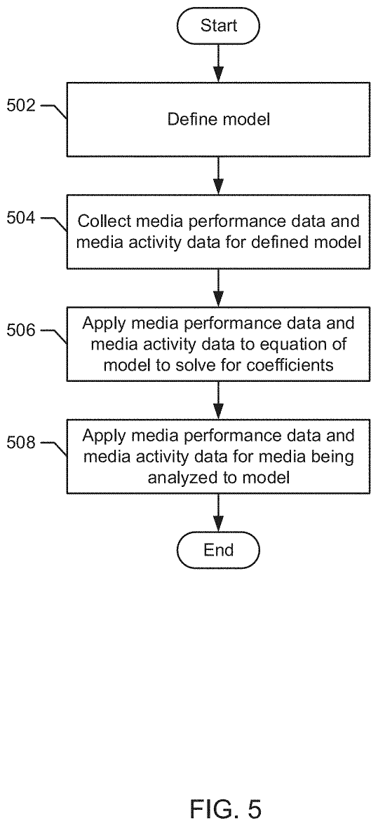

The example equity modeler 206 develops models using the interaction type data such as media performance data and/or media activity data to analyze and/or project consumer engagement with media (block 306). Models developed by the example equity modeler 206 define relationships between the media performance data and/or media activity data which may be used to predict a consumer engagement measure (e.g., ratings growth). The example equity modeler 206 uses historical media performance data and/or media activity data to create the model. The example equity modeler 206 then applies data associated with media being analyzed (e.g., for a report) to the model to determine a predicted consumer engagement measure for the media in question. An example method to develop models to predict consumer interaction with media is described below in connection with FIG. 5.

The example report generator 208 uses the results of the modeling performed at the example equity modeler 206 and/or the equity scores calculated at the example equity score calculator 204 to create reports to illustrate and/or predict engagement with the media (block 308). The example report generator 208 provides the reports to clients (e.g., the client 114) to allow the clients to analyze and/or act upon the information (e.g., to adjust marketing techniques and/or improve the effectiveness of a marketing campaign associated with the media). The example instructions of FIG. 3 then end.

FIG. 4 is a flow diagram representative of example machine readable instructions that may be executed to implement the example equity score calculator 204 of FIG. 2. The example equity score calculator 204 accesses interaction type data associated with media and calculates equity scores for the media. In the illustrated example, to calculate equity scores for the media, the example equity score calculator 204 weights types of the interaction type data (e.g., delayed media exposure data) differently (block 402).

The example equity score calculator 204 normalizes the weighted and/or unweighted interaction type data (block 404). The interaction type data may be representative of different forms of consumer interaction (e.g., which may be in different units of measure such as television ratings, DVD sales, etc.) and, thus, the example equity score calculator 204 normalizes each type of the interaction type data to a single and/or same scale to allow the interaction type data to be combined and/or compared. The example equity score calculator 204 weights each type of the normalized interaction type data (block 406). The example equity score calculator 204 then determines an equity score for the media being analyzed by summing the weighted normalized interaction type data scores for the media (block 408). The example instructions of FIG. 4 then end.

FIG. 5 is a flow diagram representative of example machine readable instructions that may be executed to implement the example equity modeler 206 of FIG. 2. The equity modeler 206 of the illustrated example develops models using media performance data and/or media activity data to project consumer engagement with media. Initially, the equity modeler 206 defines the model to be created (block 502). In the illustrated example, the model is to predicts ratings growth (or decline) of media. To predict ratings growth, the example equity modeler 206 defines the model as a combination of current media performance data (e.g., exposure duration data, media reach data, media exposure data, etc.) and past media activity data (e.g., webpage visitor data, media streaming media data, online discussion data, etc.). Specifically, in such an example, the example equity modeler 206 defines the ratings growth model as a change in ratings over a time period (e.g., from February to March) relative to a change in media performance data over the same time period (e.g., from February to March) combined with a change in media activity data over a past time period (e.g., from January to February). An example equation representative of the example model is illustrated below.

ΔY=Y₍ₜ₎−Y₍ₜ₋₁₎=a+f{X₍ₜ₎−X₍ₜ₋₁₎}+g{Z₍ₜ₋₁₎−Z₍ₜ₋₂₎}
where ΔY is the change in ratings, X is the media per f ormance data, Z is the media activity data, and a, f, and g are coefficients
   The example equity modeler 206 analyzes known data (e.g., data from previous/historical time periods) to determine (e.g., using regression or other statistical analysis) the coefficients defining the relationship between the media performance data and/or media activity data and the ratings growth.

The example equity modeler 206 of FIG. 2 collects media performance data and/or media activity data (e.g., known data for historical time periods) defined in the model for a plurality of media from the example database 202 (block 504). The example equity modeler 206 applies the collected media performance data and/or media activity data to the equation representative of the model to solve for the missing coefficients (block 506). In the illustrated example, the equity modeler 206 applies the collected media performance data and/or media activity data to the above equation and solves for the coefficients a, f, and g using, for example, a linear regression analysis. Alternatively, any other type of analysis may be used such as a spline analysis.

Once the coefficients have been determined, the example equity modeler 206 applies data associated with the media being analyzed to the model (block 508). To apply the data associated with the media being analyzed to the model, the example equity modeler 206 collects media performance data and/or media activity data for the media being analyzed from the example database 202. The media performance data and/or media activity data for the media being analyzed may be associated with a same or different time period as the historical audience measurement data used to solve the equation representative of the model to solve for the missing coefficients. The example equity modeler 206 calculates the predicted ratings growth for the media being analyzed using the equation above with the determined coefficients and the media performance data and/or media activity data. The example instructions of FIG. 5 then end.

FIG. 6 illustrates an example report 600 created by the example equity analyzer 102 of FIGS. 1 and/or 2. The report 600 of the illustrated example includes a list of top twenty media programs 604 by equity score 606. The equity scores 606 are determined by the example equity analyzer 102 for each of the media programs 604. Thus, the illustrated example provides a visual representation of the strength of the media programs 604 in terms of consumer engagement with the media programs 604. For example, Show 1 has an equity score of 10.09, indicating consumers are more engaged with Show 1 than with Show 20, which has an equity score of 3.77. The example report 600 may be used by a client (e.g., the client 114 of FIG. 1) to determine media with positive equity scores and, thus, to determine which media has engaged consumers to the largest extent. The example report 600 may be used by, for example, an advertiser, to determine which media to advertise in and/or during.

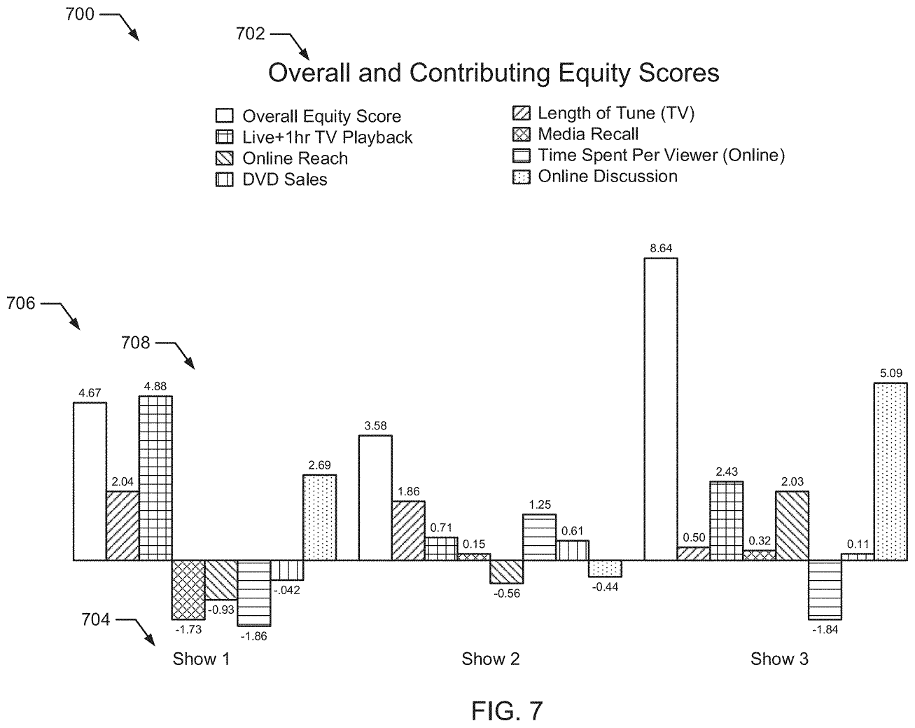

FIG. 7 illustrates another example report 700 created by the example equity analyzer 102 of FIGS. 1 and/or 2. The report 700 of the illustrated example lists example overall and contributing equity scores 702 for a plurality of example media programs 704. The example report 700 provides a graphical display of an overall equity score 706 and contributing equity scores 708. The contributing equity scores 708 are associated with different interaction type data including live and delayed media exposure data (“Live+1 hr TV Playback,” “Length of Tune (TV)”), online media exposure data (“Online Reach,” “Time Spent Per Viewer (Online)”), social media interaction data (“Online Discussion”), media purchase data (“DVD Sales”) and media performance data (“Media Recall”). The overall equity core 706 is calculated by summing the contributing equity scores 708. The contributing engagement score 708 are weighted in some examples prior to summing.

The contributing equity scores 708 of the illustrated example are provided to show example types of consumer interaction having a positive effect on the overall equity score 706 and example types of consumer interaction having a negative effect on the overall equity score 706 for the different media 704 being analyzed. For example, for Show 1, the normalized interaction type data reflects positive scores for length of media exposure, live media exposure, media that is recorded and played back within one hour of recording, and online discussion, but negative scores for program engagement, online reach, length of online exposure, and DVD sales. The example report 700 illustrates the contributing equity scores 708 to enable a client (e.g., the client 114 of FIG. 1) to determine areas to be improved upon (e.g., the interaction type data with negative contributing equity scores), and/or areas of consumer engagement to leverage (e.g., the interaction type data with positive contributing equity scores) by, for example, focusing advertising spending in such areas.

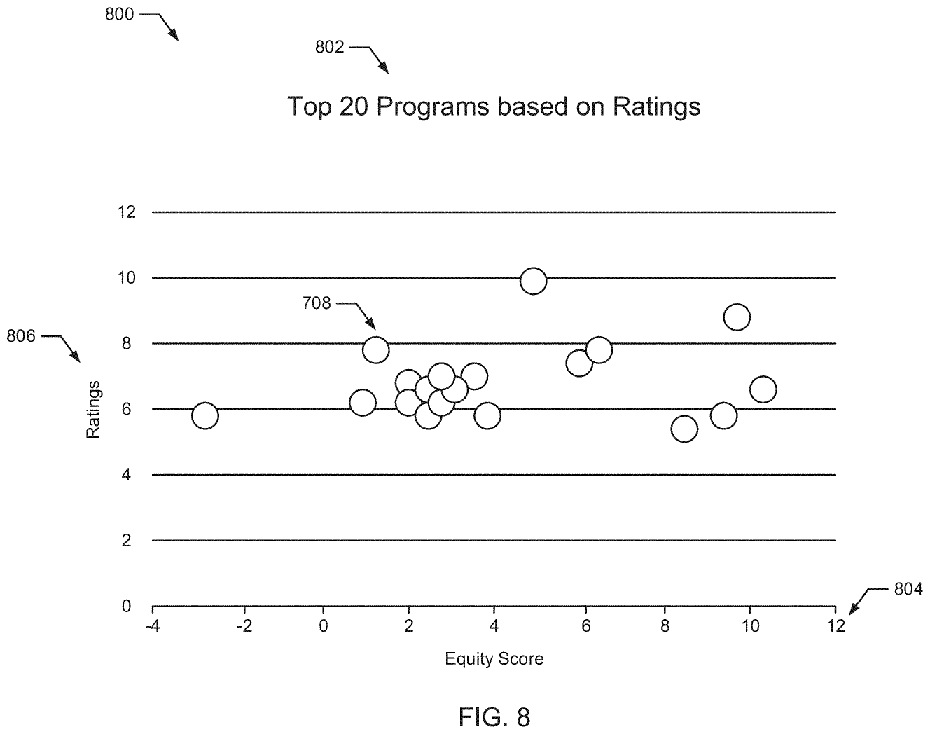

FIG. 8 illustrates another example report 800 created by the example equity analyzer 102 of FIGS. 1 and/or 2. The report 800 of the illustrated example lists top equity scores for media based on ratings 802. The example report 800 provides graphical indicators 808 comparing equity scores 804 to ratings 806 for media. The example report 800 illustrates that media with a high ratings score (e.g., 10) may have a relatively low equity score (e.g., 5), representing that although the media receives good ratings, the consumers of the media are not as engaged with the media as consumers of other media. The example report 800 also illustrates that media with a lower ratings score (e.g., 7) may have a higher equity score (e.g., 10), representing that although the media receives lower traditional ratings, the consumers of the media are more engaged with the media than consumers of other media. In such an example, a client (e.g., the client 114 of FIG. 1) may use the example report 800 to determine, for example, what media to focus an advertising campaign in, what media to increase advertising on, etc.

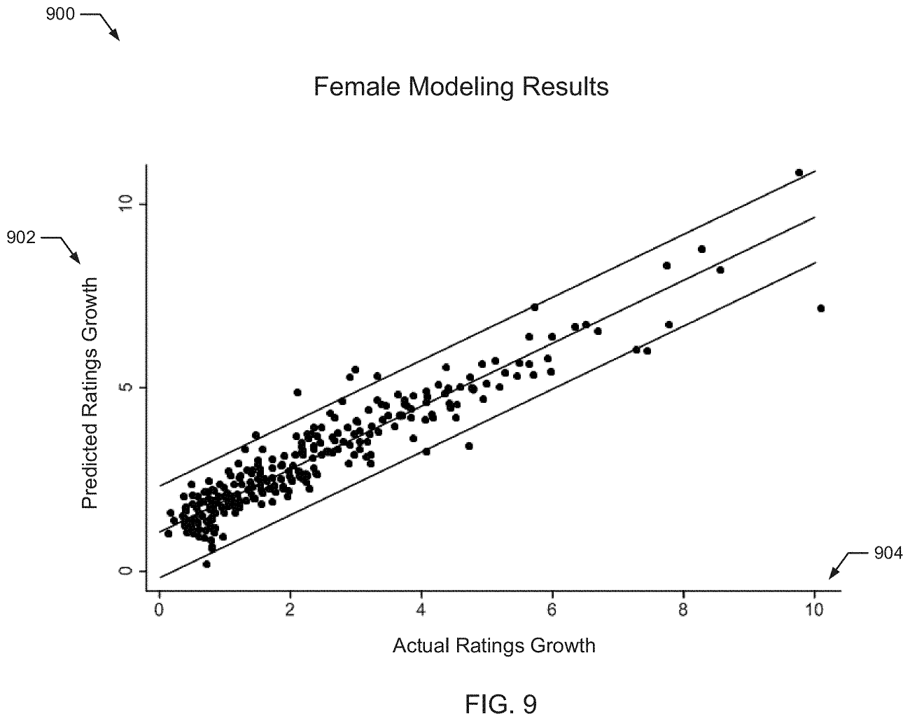

FIG. 9 illustrates another example report 900 created by the example equity analyzer 102 of FIGS. 1 and/or 2. The report 900 of the illustrated example shows results of modeling performed by the example equity analyzer 102. In the illustrated example, the example report 900 provides a visual display comparing predicted ratings growth 902 to actual ratings growth 904 for a particular demographic (e.g., females) to illustrate the effectiveness of the modeling.

FIG. 10 is a block diagram of an example processor platform 1000 capable of executing the instructions of FIGS. 3 and/or 4 to implement the example equity analyzer 102 of FIGS. 1 and/or 2. The processor platform 1000 can be, for example, a server, a personal computer, a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, or any other type of computing device.

The processor platform 1000 of the illustrated example includes a processor 1012. The processor 1012 of the illustrated example is hardware. For example, the processor 1012 can be implemented by one or more integrated circuits, logic circuits, microprocessors or controllers from any desired family or manufacturer.

The processor 1012 of the illustrated example includes a local memory 1013 (e.g., a cache). The processor 1012 of the illustrated example is in communication with a main memory including a volatile memory 1014 and a non-volatile memory 1016 via a bus 1018. The volatile memory 1014 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1016 may be implemented by flash memory and/or any other desired type of memory device. Access to the main memory 1014, 1016 is controlled by a memory controller.

The processor platform 1000 of the illustrated example also includes an interface circuit 1020. The interface circuit 1020 may be implemented by any type of interface standard, such as an Ethernet interface, a universal serial bus (USB), and/or a PCI express interface.

In the illustrated example, one or more input devices 1022 are connected to the interface circuit 1020. The input device(s) 1022 permit(s) a user to enter data and commands into the processor 1012. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 1024 are also connected to the interface circuit 1020 of the illustrated example. The output devices 924 can be implemented, for example, by display devices (e.g., a light emitting diode (LED), an organic light emitting diode (OLED), a liquid crystal display, a cathode ray tube display (CRT), a touchscreen, a tactile output device, a light emitting diode (LED), a printer and/or speakers). The interface circuit 1020 of the illustrated example, thus, typically includes a graphics driver card, a graphics driver chip or a graphics driver processor.

The interface circuit 1020 of the illustrated example also includes a communication device such as a transmitter, a receiver, a transceiver, a modem and/or network interface card to facilitate exchange of data with external machines (e.g., computing devices of any kind) via a network 1026 (e.g., an Ethernet connection, a digital subscriber line (DSL), a telephone line, coaxial cable, a cellular telephone system, etc.).

The processor platform 1000 of the illustrated example also includes one or more mass storage devices 1028 for storing software and/or data. Examples of such mass storage devices 1028 include floppy disk drives, hard drive disks, compact disk drives, Blu-ray disk drives, RAID systems, and digital versatile disk (DVD) drives.

The coded instructions 1032 of FIGS. 3 and/or 4 may be stored in the mass storage device 1028, in the volatile memory 1014, in the non-volatile memory 1016, and/or on a removable tangible computer readable storage medium such as a CD or DVD.

Examples disclosed herein facilitate measuring consumer engagement with media and using the measured consumer engagement to predict media performance characteristics such as commercial retention, advertising recall, ratings growth, etc. These new measures may provide clients (e.g., television networks, advertisers, etc.) with reports illustrating strength(s) of media and/or predicting future media characteristics (e.g., ratings growth). For example, models may be created using historical media performance data and current media performance data may be applied to the models to predict future ratings growth.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

1. (canceled)

2. A non-transitory computer readable medium comprising instructions that, when executed, cause at least one processor to at least:
query an audience measurement system via a computer-implemented network for different types of interaction data, the interaction data including exposure data and engagement data associated with access to a first episode of first media during a first time period and access to a second episode of second media during a second time period;
determine normalized interaction data scores based on a normalization of ones of the different types of the interaction data;
generate a first equity score and a second equity score based on the normalized interaction data scores, the first equity score corresponding to the first episode of the first media in the first time period, the second equity score corresponding to the second episode of the first media in the second time period;
determine first ratings for television broadcasts of the first episode of the first media during the first time period;
determine second ratings for television broadcasts of the second episode of the first media during the second time period;
predict a future rating with an engagement model, the engagement model to define a relationship between (i) the first equity score and the second equity score and (ii) the first ratings and the second ratings, the future rating associated with at least one of online streaming or a television broadcast of a third episode of the first media during a third time period; and
transmit an identification of the future rating via the computer-implemented network, the identification of the future rating to cause an adjustment of at least one of the online streaming or the television broadcast of the third episode in response to an adjustment of advertising for the at least one of the online streaming or the television broadcast of the third episode, the adjustment of the advertising based on the future rating.

3. The non-transitory computer readable medium of claim 2, wherein the interaction data includes at least one of webpage visitor data, streaming media data, or online discussion data mentioning the first media, the webpage visitor data corresponding to a first number of unique visitors to a webpage associated with the first media, the streaming media data corresponding to a second number of users accessing a portion of streaming media associated with the first media, and the online discussion data corresponding to sentiment of discussions associated with a third number of mentions of the first media on at least one of webpages or social media sites.

4. The non-transitory computer readable medium of claim 2, wherein the instructions, when executed, cause the at least one processor to:
determine that the exposure data indicates exposure to the first media by at least one of online streaming or television broadcast; and
determine that the engagement data indicates an online exchange of information that identifies the first media.

5. The non-transitory computer readable medium of claim 2, wherein the instructions, when executed, cause the at least one processor to predict the future rating in response to the adjustment of the advertising for the at least one of the online streaming or the television broadcast associated with the first media, the adjustment of the advertising to improve effectiveness of a marketing campaign associated with the first media.

6. The non-transitory computer readable medium of claim 5, wherein the engagement model includes an equation having parameters and coefficients for the parameters, and the instructions, when executed, cause the at least one processor to generate the engagement model and apply the different types of the interaction data for a fourth time period to the equation using at least one of linear regression analysis or a spline analysis to determine the coefficients, the fourth time period before the first time period, the second time period, and the third time period.

7. The non-transitory computer readable medium of claim 2, wherein the normalized interaction data scores include a normalized online streaming data score, a normalized social media interaction data score, and a normalized television broadcast data score, and the instructions, when executed, cause the at least one processor to weight at least one of the normalized online streaming data score, the normalized social media interaction data score, or the normalized television broadcast data score before the first equity score and the second equity score are generated based on the normalized interaction data scores .

8. The non-transitory computer readable medium of claim 2, wherein the instructions, when executed, cause the at least one processor to normalize the ones of the different types of the interaction data by adjusting each of the different types of the interaction data to a same scale, the different types of the interaction data initially having different scales.

9. An apparatus comprising:
memory; and
at least one processor to execute instructions to at least:
query an audience measurement system via a computer-implemented network for different types of interaction data, the interaction data including exposure data and engagement data associated with access to a first episode of first media during a first time period and access to a second episode of second media during a second time period;
determine normalized interaction data scores based on a normalization of ones of the different types of the interaction data;
generate a first equity score and a second equity score based on the normalized interaction data scores, the first equity score corresponding to the first episode of the first media in the first time period, the second equity score corresponding to the second episode of the first media in the second time period;
determine first ratings for television broadcasts of the first episode of the first media during the first time period;
determine second ratings for television broadcasts of the second episode of the first media during the second time period;
predict a future rating with an engagement model, the engagement model to define a relationship between (i) the first equity score and the second equity score and (ii) the first ratings and the second ratings, the future rating associated with at least one of online streaming or a television broadcast of a third episode of the first media during a third time period; and
transmit an identification of the future rating via the computer-implemented network, the identification of the future rating to cause an adjustment of at least one of the online streaming or the television broadcast of the third episode in response to an adjustment of advertising for the at least one of the online streaming or the television broadcast of the third episode, the adjustment of the advertising based on the future rating.

10. The apparatus of claim 9, wherein the interaction data includes at least one of webpage visitor data, streaming media data, or online discussion data mentioning the first media, the webpage visitor data corresponding to a first number of unique visitors to a webpage associated with the first media, the streaming media data corresponding to a second number of users accessing a portion of streaming media associated with the first media, and the online discussion data corresponding to sentiment of discussions associated with a third number of mentions of the first media on at least one of webpages or social media sites.

11. The apparatus of claim 9, wherein the at least one processor is to:
determine that the exposure data indicates exposure to the first media by at least one of online streaming or television broadcast; and
determine that the engagement data indicates an online exchange of information that identifies the first media.

12. The apparatus of claim 9, wherein the at least one processor is to predict the future rating in response to the adjustment of the advertising for the at least one of the online streaming or the television broadcast associated with the first media, the adjustment of the advertising to improve effectiveness of a marketing campaign associated with the first media.

13. The apparatus of claim 12, wherein the engagement model includes an equation having parameters and coefficients for the parameters, and the at least one processor is to apply the different types of the interaction data for a fourth time period to the equation using at least one of linear regression analysis or a spline analysis to determine the coefficients, the fourth time period before the first time period, the second time period, and the third time period.

14. The apparatus of claim 9, wherein the normalized interaction data scores include a normalized online streaming data score, a normalized social media interaction data score, and a normalized television broadcast data score, and the at least one processor is to weight at least one of the normalized online streaming data score, the normalized social media interaction data score, or the normalized television broadcast data score before the first equity score and the second equity score are generated based on the normalized interaction data scores.

15. The apparatus of claim 9, wherein the at least one processor is to normalize the ones of the different types of the interaction data by adjusting each of the different types of the interaction data to a same scale, the different types of the interaction data initially having different scales.

16. A system comprising:
an audience measurement system to obtain different types of interaction data, the interaction data including exposure data and engagement data associated with access to a first episode of first media during a first time period and access to a second episode of second media during a second time period; and
a central facility to:
obtain the different types of the interaction data from the audience measurement system via a computer-implemented network;
determine normalized interaction data scores based on a normalization of ones of the different types of the interaction data;
generate a first equity score and a second equity score based on the normalized interaction data scores, the first equity score corresponding to the first episode of the first media in the first time period, the second equity score corresponding to the second episode of the first media in the second time period;
determine first ratings for television broadcasts of the first episode of the first media during the first time period;
determine second ratings for television broadcasts of the second episode of the first media during the second time period;
predict a future rating with an engagement model, the engagement model to define a relationship between (i) the first equity score and the second equity score and (ii) the first ratings and the second ratings, the future rating associated with at least one of online streaming or a television broadcast of a third episode of the first media during a third time period; and
transmit an identification of the future rating via the computer-implemented network, the identification of the future rating to cause an adjustment of at least one of the online streaming or the television broadcast of the third episode in response to an adjustment of advertising for the at least one of the online streaming or the television broadcast of the third episode, the adjustment of the advertising based on the future rating.

17. The system of claim 16, wherein the interaction data includes at least one of webpage visitor data, streaming media data, or online discussion data mentioning the first media, the webpage visitor data corresponding to a first number of unique visitors to a webpage associated with the first media, the streaming media data corresponding to a second number of users accessing a portion of streaming media associated with the first media, and the online discussion data corresponding to sentiment of discussions associated with a third number of mentions of the first media on at least one of webpages or social media sites.

18. The system of claim 16, wherein the central facility is to predict the future rating in response to the adjustment of the advertising for the at least one of the online streaming or the television broadcast associated with the first media, the adjustment of the advertising to improve effectiveness of a marketing campaign associated with the first media.

19. The system of claim 18, wherein the engagement model includes an equation having parameters and coefficients for the parameters, and the central facility is to generate the engagement model and apply the different types of the interaction data for a fourth time period to the equation using at least one of linear regression analysis or a spline analysis to determine the coefficients, the fourth time period before the first time period, the second time period, and the third time period.

20. The system of claim 16, wherein the normalized interaction data scores include a normalized online streaming data score, a normalized social media interaction data score, and a normalized television broadcast data score, and the central facility is to weight at least one of the normalized online streaming data score, the normalized social media interaction data score, or the normalized television broadcast data score before the first equity score and the second equity score are generated based on the normalized interaction data scores.

21. The system of claim 16, wherein the central facility is to normalize the ones of the different types of the interaction data by adjusting each of the different types of the interaction data to a same scale, the different types of the interaction data initially having different scales.
